(19) United States
(12) Patent Application Publication
(10) Pub. No.: US 2013/0078863 A1
(43) Pub. Date: Mar. 28, 2013

(54) ELECTRICAL CONNECTOR

(71) Applicant: CHIH-HSIEN CHIANG, New Taipei (TW)

(72) Inventor: CHIH-HSIEN CHIANG, New Taipei (TW)

(73) Assignee: Cheng Uei Precision Industry Co., Ltd., New Taipei City (TW)

(21) Appl. No.: 13/239,507

(22) Filed: Sep. 22, 2011

(51) Int. Cl. H01R 24/66

(52) U.S. Cl. 439/660

(57) ABSTRACT

Disclosed is an electrical connector, which includes an insulative body and conductive terminals received and fixed in the insulative body. The conductive terminal herein has a base. One end of the base is obliquely extended downward to form a first contacting portion of a middle-hollowed structure. The second contacting portion of the middle-hollowed structure is extended and bent outward from the one end of the first contacting portion. A complementary terminal of a complementary connector is inserted into the middle-hollowed structure from the second contacting portion. By inserting in the way of through the middle-hollowed structure, conductive terminals are not easily bent out of shape, such that connections between the conductive terminals and the complementary terminals are more stable, thereby ensuring quality performance of the electrical connector.

### FIELD OF THE INVENTION

The present invention relates to a connector, and especially to an electrical connector.

### BACKGROUND OF THE INVENTION

At present, various circuit boards are disposed in many electrical products, and a pin header is disposed in every circuit board for signal transmission between two circuit boards. A cable is connected to the circuit board via the pin header so as to achieve the signal transmission.

In order to facilitate an assembly or separate two circuit boards, a cable connector is useful for such purpose. Currently, a conventional cable connector consists of an electrical connector and a complementary connector that are coupled to each other. The electrical connector includes an insulative body and a plurality of conductive terminals being received and fixed in the insulative body. The complementary connector includes an insulative body and a plurality of complementary terminals received in the insulative body. One end of the conductive terminal and one end of the complementary terminal are respectively coupled to two circuit boards via a plurality of cables, and an opposite end of the conductive terminal and an opposite end of the complementary terminal are inserted into each other for realizing an electrical connection between the electrical connector and the complementary connector, thereby ultimately realizing the electrical connection between the two circuit boards.

The conductive terminal is bent to form a planar contacting portion, thereby contacting the complementary terminal when the complementary terminal is inserted into the conductive terminal. By inserting in this way, it is easy to bend the conductive terminal out of shape, such that the connection between the conductive terminal and the complementary terminal is instable, thus affecting quality performance of the electrical connector.

Therefore, there is a significant need to provide an improved electrical connector without bending out of shape the complementary terminal when it is inserted into the conductive terminal, thereby making the connection between the conductive terminal and the complementary terminal more stable, thus ensuring quality performance of the electrical connector.

### SUMMARY OF THE INVENTION

An objective of the present invention is to provide an electrical connector to overcome the above-mentioned drawback. The electrical connector can prevent the conductive terminal from being bent out of shape when the complementary terminal is inserted into the conductive terminal, thus the connection between the conductive terminal and the complementary terminal is more stable, thereby ensuring quality performance of the electrical connector.

To achieve the foregoing objective, the present invention proposes an electrical connector which includes an insulative body and a plurality of conductive terminals being received and fixed in the insulative body. Each of the conductive terminals herein has a base, and one end of the base is extended obliquely downward to form a first contacting portion of a middle-hollowed structure. A second contacting portion of the middle-hollowed structure is formed by the one end of the first contacting portion extending and bending outwardly, and a complementary terminal of a complementary connector is inserted through the second contacting portion into the middle-hollowed structure.

Furthermore, the complementary terminal is held by the two protrusions which are formed as the second contacting portion of the middle-hollowed structure.

Furthermore, one end of the second contacting portion is extended and bent to form a third contacting portion of the middle-hollowed structure, and the first contacting portion is connected with the second contacting portion and the third contacting portion to form a U-shape, whereby the complementary terminal is inserted into the middle-hollowed structure as well as contacts the third contacting portion.

Furthermore, the above-mentioned third contacting portion is obliquely inclined toward the first contacting portion.

In comparison with the prior art, the conductive terminal of the electrical connector of the present invention having the base by having one end of the base extending obliquely downward to form the first contacting portion of the middle-hollowed structure. The second contacting portion of the middle-hollowed structure is extended and bent outwardly from one end of the first contacting portion. The complementary terminal is inserted into the middle-hollowed structure from the second contacting portion. By inserting in the way of through the middle-hollowed structure, the conductive terminals are not easily bent out of shape, such that connections between the conductive terminals and the complementary terminals are more stable, thereby ensuring quality performance of the electrical connector.

It is to be understood that both the foregoing general description and the following detailed description of the present invention are exemplary and explanatory that are intended to provide further explanation of the invention as claimed.

### BRIEF DESCRIPTION OF THE DRAWINGS

FIG. 1 is a perspective view illustrating a cable connector consisting of an electrical connector of the present invention assembling with a complementary connector according to one preferred embodiment of the present invention;

FIG. 2 is an exploded view of FIG. 1;

FIG. 3 is a perspective view illustrating the a complementary terminal of FIG. 1 being inserted into a conductive terminal of the electrical connector;

FIG. 4 is an exploded view of FIG. 3;

FIG. 5 is a main perspective view illustrating the conductive terminal of FIG. 4; and

FIG. 6 is a lateral view of FIG. 5.

### DETAILED DESCRIPTION OF THE PREFERRED EMBODIMENTS

The present invention will now be described in detail with reference to a few preferred embodiments thereof as illustrated in the accompanying drawings. The same reference numerals refer to the same parts or like parts throughout the various figures.

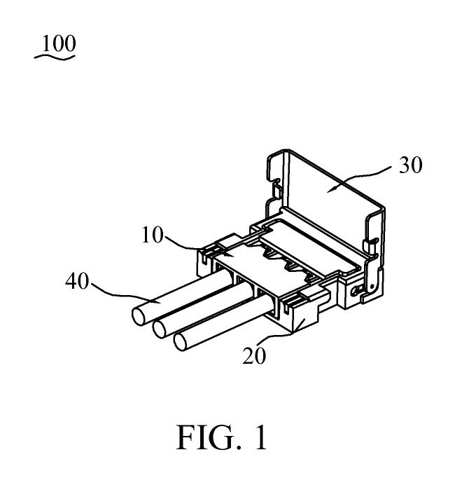

As mentioned above, referring to FIG. 1, a cable connector 100 consists of an electrical connector 10 of the present invention and a complementary connector 20, which are inserted into each other for realizing an electrical connection thereof. The cable connector 100 further includes a metal case 30 which is slidably disposed on the complementary connector 20, and the metal case 30 can be engaged in or separated from the complementary connector 20.

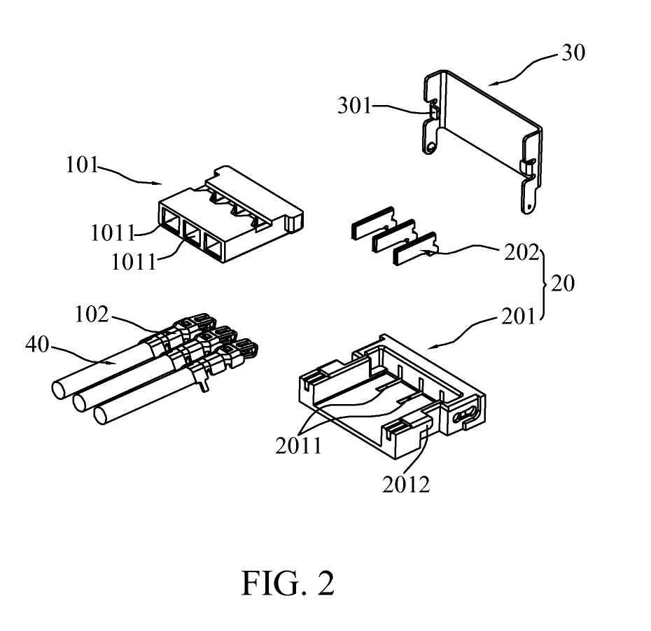

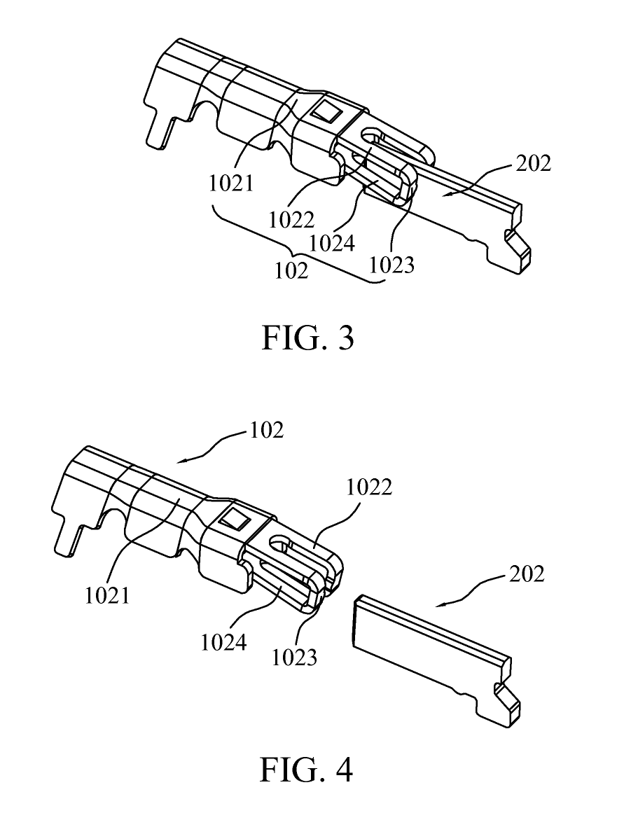

Specifically, referring to FIG. 2, the electrical connector 10 includes an insulative body 101 and a plurality of conductive terminals 102. A plurality of terminal slots 1011 are defined in the insulative body 101. Each of the conductive terminals 102 is received and fixed in each of the terminal slots 1011. The complementary connector 20 includes an insulative body 201 and a plurality of complementary terminals 202. A plurality of terminal slots 2011 are defined in the insulative body 201. Each of the complementary terminals 202 is received and fixed in each of the terminal slots 2011. One end of the conductive terminal 102 and one end of the complementary terminal 202 are respectively coupled to two circuit boards via cables 40. The figures only show that the conductive terminals 102 are electrically coupled to the cables 40, and the circuit boards are not shown in the figures. An opposite end of the conductive terminal 102 and an opposite end of the complementary terminal 202 are inserted into each other (as shown in FIG. 3) for realizing an electrical connection between the two circuit boards.

Specifically, engaging grooves 2012 are disposed on the insulative body 201, and engaging portions 301 are disposed on the metal case. A holding force of the connection between the electrical connector 10 and the complementary connector 20 can be realized by the metal case 30 when the engaging portion 301 is engaged with the engaging groove 2012, so that the electrical connector 10 and the complementary connector 20 are kept to maintain a better contact. When the engaging portion 301 is detached from the engaging groove 2012, the electrical connector 10 can be detached freely from the complementary connector 20.

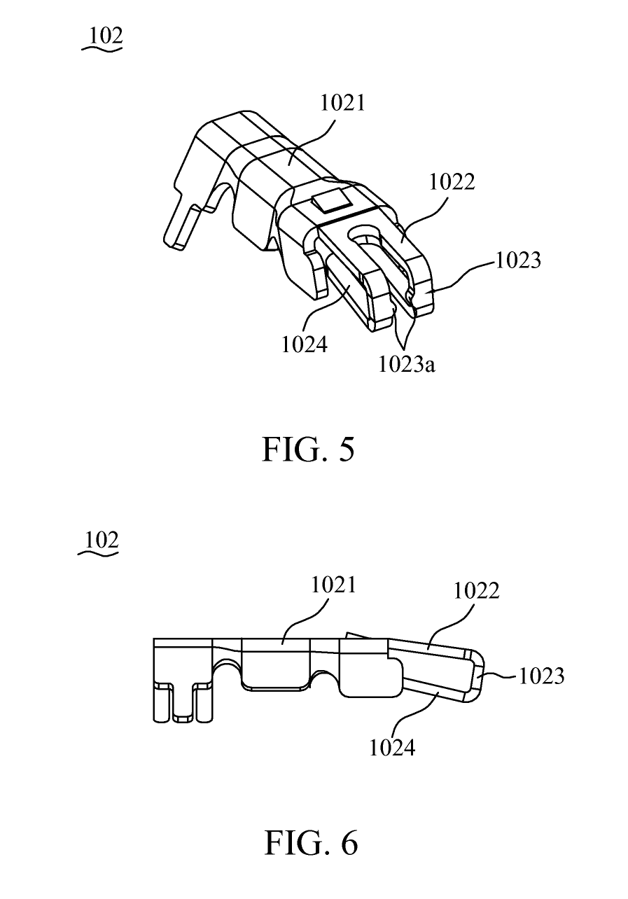

Referring to FIG. 3 to FIG. 6, each of the conductive terminals 102 has a base 1021. A first contacting portion 1022 of a middle-hollowed structure is formed by one end of the base 1021 inclining and extending downward. One end of the first contacting portion 1022 of the middle-hollowed structure is bent and extended outward to form the second contacting portion 1023 of the middle-hollowed structure. One end of the second contacting portion 1023 is bent and extended to form a third contacting portion 1024 of the middle-hollowed structure, and an assembly of the first contacting portion 1022, the second contacting portion 1023, and the third contacting portion 1024 form a U-shape. The third contacting portion 1024 is inclined toward the first contacting portion 1022. The complementary terminal 202 is inserted into the middle-hollowed structure and contacts the third contacting portion 1024. Because the first contacting portion 1022 and the third contacting portion 1024 are obliquely formed, a contacting length between the complementary terminal 202 and the conductive terminal 102 can be increased. Thus, the conductive terminal 102 can well contact the complementary terminal 202.

Furthermore, the complementary terminal 202 is held by the two protrusions 1023a which are formed as the second contacting portion 1023 of the middle-hollowed structure.

As mentioned above, the complementary terminal 202 of the electrical connector 10 of the present invention is inserted into the middle-hollowed structure of the conductive terminal 102 from the second contacting portion 1023. By inserting in the way of through the middle-hollowed structure, the conductive terminal 102 is not easily bent out of shape, so that the connection between the conductive terminal 102 and the complementary terminal 202 is more stable, thereby ensuring quality performance of the electrical connector 10.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An electrical connector, comprising an insulative body and a plurality of conductive terminals being received and fixed in the insulative body, wherein each of the conductive terminals has a base having one end which is extended obliquely downward to form a first contacting portion of a middle-hollowed structure, and the first contacting portion having one end which is extended and bent outwardly to form a second contacting portion of the middle-hollowed structure, whereby a complementary terminal of a complementary connector is inserted through the second contacting portion into the middle-hollowed structure.

2. The electrical connector of claim 1, wherein a complementary terminal is held by the two protrusions which are formed as the second contacting portion of the middle-hollowed structure.

3. The electrical connector of claim 1, wherein a third contacting portion of the middle-hollowed structure is extended and bent from one end of the second contacting portion, and an assembly of the first contacting portion, the second contacting portion, and the third contacting portion form a U-shape.

4. The electrical connector of claim 3, wherein the third contacting portion of the middle-hollowed structure is inclined toward the first contacting portion of the middle-hollowed structure.
